(19) United States
(12) Patent Application Publication
(10) Pub. No.: US 2010/0106683 A1
(43) Pub. Date: Apr. 29, 2010

(54) COMPUTER SYSTEM AND REPLICATION METHOD FOR THE COMPUTER SYSTEM

(76) Inventors: Toyohiro NOMOTO, Yokohama (JP); Tadashi TAKEUCHI, Sagamihara (JP)

Correspondence Address: MATTINGLY & MALUR, P.C., 1800 DIAGONAL ROAD, SUITE 370, ALEXANDRIA, VA, 22314, US

(21) Appl. No.: 12/359,664

(22) Filed: Jan. 26, 2009

(30) Foreign Application Priority Data
Oct. 23, 2008 (JP) 2008-272604

(51) Int. Cl. G06F 7/00; G06F 17/00

(52) U.S. Cl. 707/610; 707/E17.01

(57) ABSTRACT

A streaming server program delivers the content from an original content storage area in a storage apparatus, and a server computer monitors the content delivery status and creates, in a pool storage area, replicated data of the content that satisfies replicated content creation and deletion standards. Upon delivery of the replicated content, an attempt is made to resolve a delivery bottleneck by delivering data from both the original and pool storage areas. Burdens on the administrator are reduced according to the present invention by automatically detecting concentration of accesses or flash crowd and automatically replicating the whole or part of the content, thereby eliminating the need for prediction.

### CROSS-REFERENCE TO RELATED APPLICATIONS

This application relates to and claims priority from Japanese Patent Application No. 2008-272604, filed on Oct. 23, 2008, the entire disclosure of which is incorporated herein by reference.

### BACKGROUND

1. Field of the Invention

The invention relates to a storage apparatus for storing the content mainly for a streaming server, and a computer system, and the invention also relates to a method for replicating the content and delivering it efficiently.

2. Description of Related Art

In a system of, for example, a streaming service for delivering media content such as motion pictures and videos, the media content is stored in storage units, delivery software such as a Windows (registered trademark) Media Server is operated on the server, and the media content is provided in the streaming system. In the streaming system, delivery performance is influenced by the throughput of the delivery server and the throughput of the storage units.

When certain content becomes extremely popular in a streaming service, disk performance of storage units may become a bottleneck and the delivery performance may thereby degrade. In order to solve this problem, there is a method of avoiding the bottleneck by creating, in advance, replicated data of the content that might become popular, and storing them in the storage units; however, an administrator has to perform the method and, therefore, a heavy burden is imposed on the administrator. Also, there is a method of dynamically creating replicated data of the content as dynamic mirroring of the content (see Japanese Patent Application Laid-Open (Kokai) Publication No. 2003-67279).

Although the technique disclosed in Japanese Patent Application Laid-Open (Kokai) Publication No. 2003-67279 reduces the burden on the administrator, it only considers a CPU load on servers, the number of content transfer sessions, and throughput, and these are not parameters specific to streaming media. Furthermore, mirroring is performed between servers and, therefore, the above-mentioned technique is designed on the premise that a plurality of servers are used. As a result, the cost for equipment required for delivery is expensive.

### SUMMARY

It is an object of the present invention to monitor concentration of accesses or flash crowd in a computer system composed of storage units for storing the content and servers, and reduce a burden on the administrator at inexpensive equipment cost.

In order to solve the problems described above, the present invention is configured as follows:

A computer system includes a server computer and a storage apparatus connected to the server computer, and the storage apparatus has a first storage unit and a second storage unit. If access is made to streaming data stored in the first storage unit, the server computer delivers the data from the first storage unit. If the access to the data satisfies specified conditions, the server computer notifies the storage apparatus of the range of the data to be replicated. The storage apparatus replicates the notified range of the data from the first storage unit to the second storage unit.

The server computer measures delivery time from the start of delivery to the end of delivery; and based on the delivery time and the number of client computers to which the data was delivered until the end of the delivery time, the server computer finds a point of time when the number of client computers to which the data was delivered until the end of the delivery time becomes equal to or less than a certain ratio; and the server computer determines that the range of the data delivered until the number of client computers becomes equal to or less than the certain ratio should be replicated.

The server computer measures the frequency of access to the data; and if the frequency of access to the data is equal to or more than a certain value, the server computer notifies the storage apparatus of replication of the data.

The server computer measures the frequency of access to the replicated data; and if the frequency of access to the replicated data is equal to or more than a certain value, the server computer notifies the storage apparatus of replication of the replicated data.

If access is made to the data, the server computer delivers either the data stored in the first storage unit or the replicated stored in the second storage unit.

The server computer stores a correspondence relationship between logical block addresses of the data and logical block addresses of the replicated data; and if access is made to a block constituting the data and if there is a block constituting the replicated data corresponding to the block constituting the data, the server computer delivers the block constituting the data or the block constituting the replicated data.

When replicating the data, the server computer checks if the second storage unit has any area for storing the data; and if the second storage unit has no area for storing the data, and if access to data stored in the second storage unit satisfies specified conditions, the server computer notifies the storage apparatus of an instruction to delete the data in the second storage unit, and the storage apparatus deletes the data concerning which it has received the instruction.

The server computer measures the frequency of access to the data in the second storage unit; and if the access frequency is lower than a certain value, the server computer determines to delete the data in the second storage unit.

The present invention can inhibit a storage bottleneck upon concentration of accesses or flash crowd in a streaming system and reduce the management cost by determining the details of replication based on content access pattern information, and automatically replicating the content.

Other aspects and advantages of the invention will be apparent from the following description and the appended claims.

### BRIEF DESCRIPTION OF THE DRAWINGS

FIG. 1 shows an example of the hardware configuration of a computer system.

FIG. 2 shows an example of the logical configuration of the computer system.

FIG. 3 shows an example of access pattern information.

FIG. 4 shows an example of original content information.

FIG. 5 shows an example of replicated content information.

FIG. 6 shows an example of replicated content creation and deletion standards.

FIG. 7 shows an example of pool selection standards.

FIG. 8 shows an example of replication details and performance prediction information.

FIG. 9 shows an example of pool management information.

FIG. 10 shows an example of delivery target information.

FIG. 11 is a flowchart illustrating an example of content replication processing.

FIG. 12 is a flowchart illustrating an example of processing for deleting replicated content.

FIG. 13 is a flowchart illustrating an example of performance prediction processing in the case of replication of the content.

FIG. 14 is a flowchart illustrating an example of block information management processing executed by a content management unit.

FIG. 15 shows an example of original-to-replicated blocks correspondence information.

FIG. 16 shows an example of access distribution processing executed by a driver or a storage apparatus.

### DETAILED DESCRIPTION OF PREFERRED EMBODIMENTS

Embodiments of the present invention will be explained below in detail. However, the invention is not limited to those embodiments, and the invention also includes configurations similar to those described in the following embodiments.

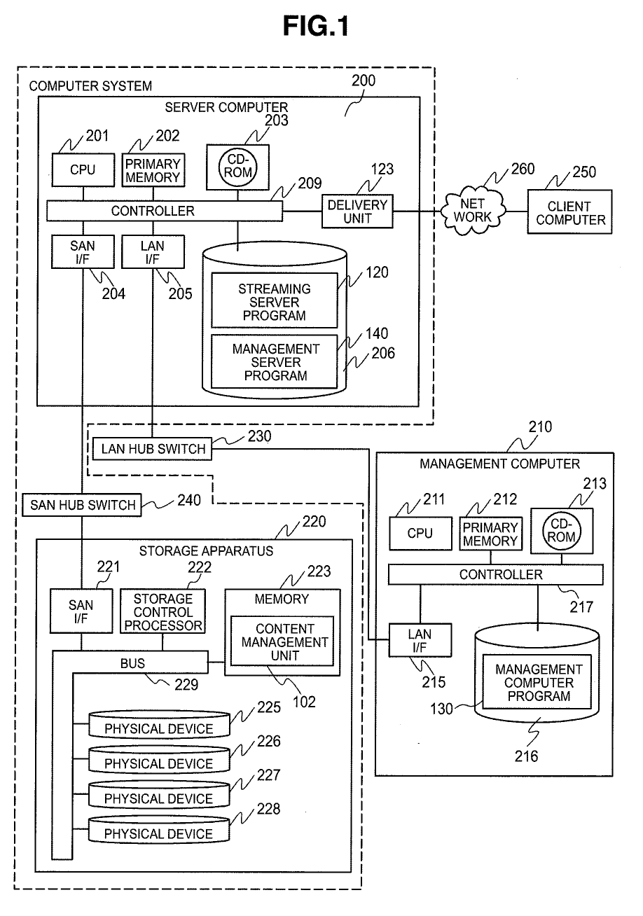

FIG. 1 is a diagram illustrating an example of the configuration of a computer system according to an embodiment of the present invention.

The computer system is composed of a server computer 200 and a storage apparatus 220. The computer system is connected to a management computer 210 and a client computer 250.

The server computer 200 and the management computer 210 are connected to each other via a LAN (Local Area Network) hub (or switch) 230 and cables. The LAN hub (or switch) 230 and the network may sometimes collectively be called a LAN. Incidentally, the network connecting the server computer 200 and the management computer 210 may not be a LAN.

The server computer 200 and the storage apparatus 220 are connected to each other via a SAN (Storage Area Network) hub (or switch) 240 and cables. The SAN hub 240 and the network may sometimes collectively be called a SAN. Incidentally, the network connecting the server computer 200 and the storage apparatus 240 may not be a SAN.

The server computer 200 and the client computer 250 are connected via a network 260. Incidentally, the network connecting the server computer 200 and the client computer 250 is, for example, a LAN, a SAN, or a WAN (Wide Area Network).

The server computer 200 has a CPU 201, primary memory 202, a CD-ROM device 203, a SAN I/F 204, a LAN I/F 205, a disk device 206, and a delivery unit 123. These devices are connected mutually via a controller 209.

Programs and data such as a streaming server program 120 and a management server program 140 are stored in the disk device 206. The CPU 201 loads these programs to the primary memory 202 and executes them.

These programs and data may be stored in a disk device 216 for the management computer 210 or in physical devices for the storage apparatus 220.

The CPU 201 executes the streaming server program 120, reads the content stored in the storage apparatus 220, delivers it to the client computer 250, and outputs access pattern information 121 of the content. The CPU 201 also executes the management server program 140, collects access pattern information 121 about the content, judges whether or not to replicate the content, and then sends an instruction for replication to the storage apparatus 220.

The content herein means moving image data such as motion pictures and the moving images are reproduced with time. This data contains an image portion and a sound portion. Also, this data is composed of key frames and differential frames. The content reproduction modes include, for example, reproduction at normal speed, fast-feeding, fast rewind, and pause. Furthermore, the content may be reproduced from the middle of the content or reproduction of the content may be stopped in the middle of the content.

The management computer 210 executes and manages the streaming server program 120 and the management server program 140 and sets a delivery target and selects a pool to be used. An administrator of the computer system manages and updates the computer system, using the management computer 210.

The management computer 210 has a CPU 211, primary memory 212, a CD-ROM device 213, a LAN I/F 214, a disk device 216 and a controller 217 for mutually connecting the above-mentioned devices.

The disk device 216 for the management computer 210 stores a management computer program 130.

These programs and data may be stored in the disk device 206 for the server computer 200 or in physical devices for the storage apparatus 220.

The storage apparatus 220 has a SAN I/F 221, a storage control processor 222, memory 223, and physical devices 225-228. These devices are connected mutually via a bus 229. The storage control processor 222 reads the content management unit 102 and stores it in the memory 223 in the storage apparatus 220 and receives block information and update tables. The physical devices 225-228 are, for example, HDDs (Hard Disk Drives) or SSDs (Solid State Devices).

Incidentally, the configuration including the server computer 200, the management computer 210, and the storage apparatus 220 is employed in this embodiment, but the above configuration may be embodied by one computer and a storage apparatus. Furthermore, there may be a plurality of server computers 200, management computers 210, storage apparatuses 220, and client computers 208, respectively.

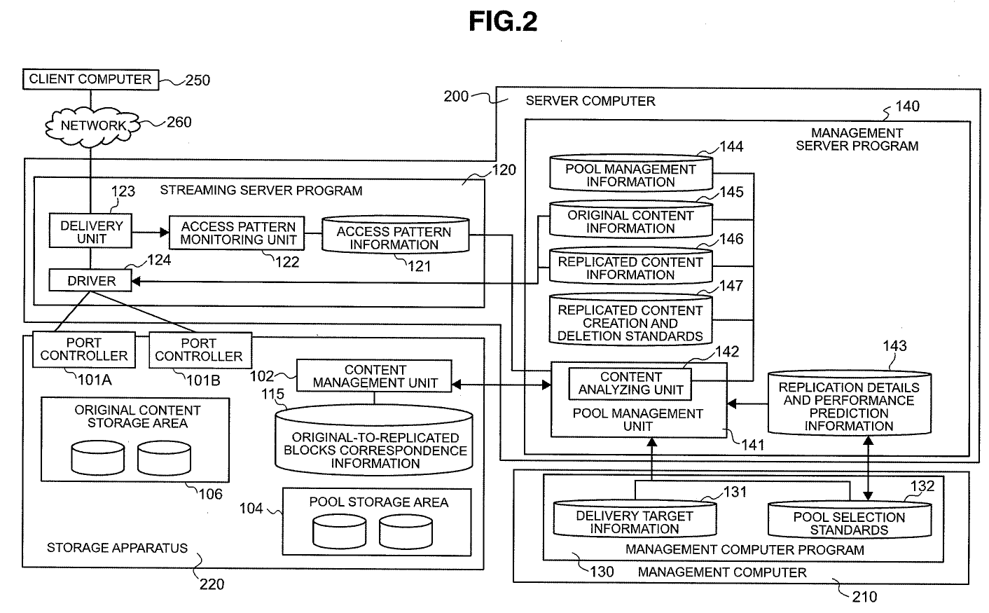

FIG. 2 is a diagram illustrating an example of the program configuration and data configuration according to this embodiment. Referring to this diagram, an example in which the streaming server program 120, the storage apparatus 220 storing the content, the management server program 140 for managing the content, and the management computer program 130 for managing, for example, the delivery target are explained as an example. Incidentally, delivery target information 131, pool selection standards 132, replication details and performance prediction information 143, pool management information 144, original content information 145, replicated content information 146, and replicated content creation and deletion standards 147 are located at arbitrary locations. Details of these pieces of information will be described later in detail.

Incidentally, part of the following components may be embodied by dedicated hardware.

The streaming server program 120 reads the content stored in the storage apparatus 220, using the driver 124; delivers the content to the client computer 250, using the delivery unit 123; and outputs the access pattern information 121, using the access pattern monitoring unit 122.

The pool management unit 141 monitors the access pattern information 121, checks it with the replicated content creation and deletion standards 147, and determines that the content satisfying the content should be replicated. When replicating the content, the pool management unit 141 determines the portion to be replicated, such as only the beginning of the content or only key frames, as necessary, and then determines the pool to store the replicated content. The pool management unit 141 sends an instruction for replication to the storage apparatus 220.

The content management unit 102 for the storage apparatus 220 replicates the content of the original content storage area 106 and stores it in the pool storage area 104 based on the information received from the pool management unit 141.

If a delivery request is made regarding the replicated content, the driver 124 distributes an access load by, for example, obtaining data alternately from the original content storage area and the pool storage area based on the original content information 145 and the replicated content information 146. For this purpose, a plurality of port controllers 101A and 101B may also be used to further reduce the load. After receiving a request to the content from the driver 124, the storage apparatus 220 may distribute the load on the storage side by, for example, obtaining data alternately from the original content storage area 106 and the pool storage area 104, using original-to-replicated blocks correspondence information 115.

The management computer program 130 defines the delivery target information 131 and the pool selection standards 132.

The outline of the processing executed by the computer system according to this embodiment will be explained below. Incidentally, if a program is the subject of the explanation below, a device executing the relevant program is one that actually executes the processing.

The computer system administrator sets a target value 1004 and the order of preference 1005 for the delivery target information 131, the priority 703 for the pool selection standards 132, and the value 604 for the replicated content creation and deletion standards 147, using the management computer program 130. The computer system administrator also manages activation and termination of the streaming server program 120 and the management server program.

Processing to be executed in the case of concentration of accesses or flash crowd during ordinary delivery will be explained below.

The streaming server program 120 reads the content stored in the original content storage area 106 of the storage apparatus 220 using the delivery unit 123 and delivers it to the client computer 250; and at the same time, the access pattern monitoring unit 122 monitors the delivery status and outputs the access pattern information 121.

The pool management unit 141 for the management server program 140 monitors the access pattern information 121 and checks it with the replicated content creation and deletion standards 147; if there is any content that is being delivered and satisfies the replicated content creation standards, the pool management unit 141 searches for the pool storage area 104 capable of storing the content based on the pool management information 144, and performs performance prediction using the replication details and performance prediction information 143 about the case where the relevant content is to be stored in a pool capable of storing it. Upon the performance prediction, the pool management unit 141 also forms an estimate of the case of preprocessing of the content as necessary, using the content analyzing unit 142. Subsequently, the pool management unit 141 determines the pool to be assigned, using the pool selection standards 132, and sends an instruction for replication to the content management unit 102.

The storage apparatus 220 replicates the content stored in the original content storage area 106 and stores the replicated content in the pool storage area 104 based on the information received form the content management unit 102, updates the pool management information 144, and notifies the management server program 140 of the replication.

After replicating the content, the pool management unit 141 updates the pool management information 144, the replicated content information 146, and the original content information 144. The management server program 140 notifies the driver 124 for the streaming server program of information about the content for which accesses are distributed, based on the original content information 145 and the replicated content information 146. When delivering the relevant content, the streaming server program 120 prevents degradation of the delivery performance by receiving and delivering the relevant data from both the original content storage area 106 and the pool storage area 104, using the driver 124.

Incidentally, upon distribution of accesses, the storage apparatus 220 may be used, instead of the driver 124 to prevent degradation of the delivery performance by acquiring and sending the relevant data from both the original content storage area 106 and the pool storage area 104, using the original-to-replicated blocks correspondence information 115.

Next, deletion of the content replicated in the pool will be explained below. The pool management unit 141 regularly monitors the access pattern information 121 and checks it with the replicated content creation and deletion standards 147. If any content that satisfies the standards for deleting the replicated content stored in the pool exists, the pool management unit 141 searches the replicated content information 146 for the pool storage area storing the relevant content and notifies the content management unit 102 of release of the relevant block. After receiving the notice, the content management unit 102 releases assignment of the pool storage area, updates the original-to-replicated blocks correspondence information 115 and the pool management information 144, and notifies the pool management unit 141 to that effect. The pool management unit 141 updates the original content information 145 and the replicated content information 146.

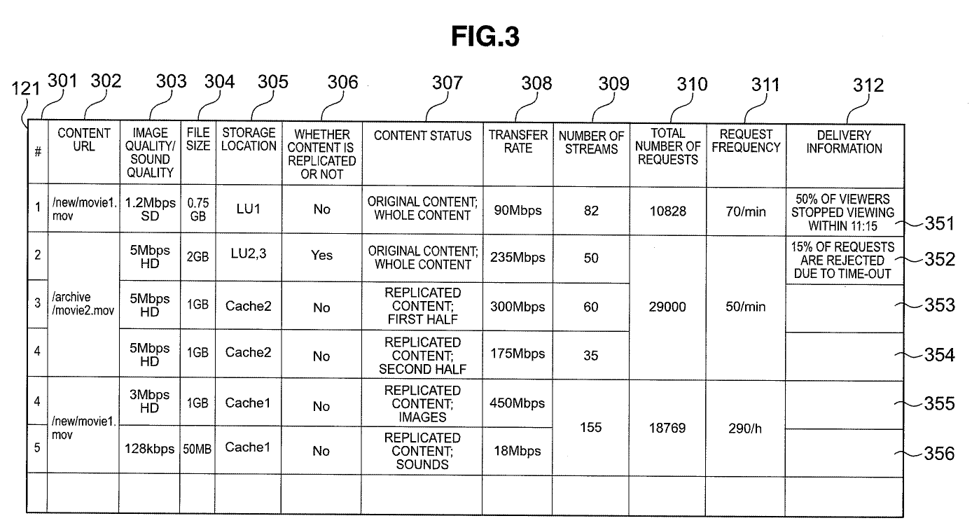

FIG. 3 shows the access pattern information 121 for recording a list of content to be delivered, the properties of the content, and the status of requests and delivery.

The access pattern information 121 includes an “ID” field 301, a “content URL” field 302, an “image quality/sound quality” field 303, a “file size” field 304, a “storage location” field 305, a “whether the replicated content exists or not” field 306, a “content status” field 307, a “current transfer rate” field 308, a “number of streams” field 309, a “total number of requests” field 310, a “request frequency” field 311, and a “delivery information” field 312.

Incidentally, the fields of the access pattern information 121 are not limited to those listed above, and the access pattern information 121 may include fields for describing information about other access patterns. Also, the access pattern information 121 describes records for each content, but the information collected from another point of view may be represented as one record.

The “content URL” field 302 indicates a content delivery URL. The “image quality/sound quality” field 303 indicates, for example, a content rate and SD (standard definition) or HD (high definition). The “file size” field 304 indicates the file size of the content. The “storage location” field 305 indicates, for example, an LU or Cache where the relevant content is stored. The “whether the replicated content exists or not” field 306 stores “Yes” if the content is replicated; the field 306 stores “NO” if the content is not replicated; and if the relevant content is a replicated content, the field 306 stores “YES”. The “content status” field 307 stores information about whether or not the content is original or replicated, and the details of the content. If the whole content is stored in the relevant storage location, the field 307 stores “whole”; of if the first half of the content is stored, the field 307 stores “first half”; or if the image portion is stored, the field 307 stores “images.” In addition, if part of the content is stored in the relevant storage location, the details of the content such as “10 minutes from the beginning,” “from 25 minutes to 45 minutes,” or “key frames.” The “transfer rate” field 308 indicates the current transfer rate for delivering the content from the server. The “number of streams” field 309 indicates the number of streams that are now being delivered. The “total number of requests” field 310 indicates the total number of requests that have been made up to date for the relevant content. The number of requests made for a specified period of time (such as one hour, one day, or one week) may be indicated. The “request frequency” field 311 indicates the number of requests per unit time. Whether the replicated content should be created or not is determined based on the request frequency. The “delivery information” field 312 indicates the status of requests for the content and the status of delivery. For example, the field 312 indicates information such as “50% of client computers stopped delivery by 11 minutes and 15 seconds after the start of delivery of the content, or 15% of the requests are rejected without delivering the content due to timeout. The delivery information may include information about frames/chapters delivered at normal speed (whose entire frames were sent in actual reproduction time), chapters that were fast-fed or skipped (for example, only I frame was sent or a request for the next chapter was received before sending the entire frames), or chapters that were posed (temporarily stopped during reproduction). The delivery information 312 is used to, for example, judge whether the content should be replicated or not, and determine the range of the content to be replicated.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

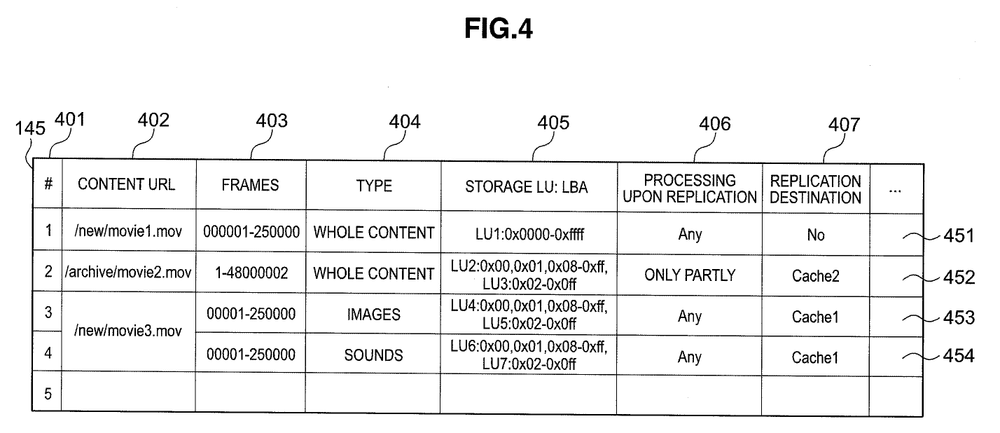

FIG. 4 is the original content information 145 showing the original content storage status.

The original content information 145 includes a “content URL” field 402, a “frame” field 403, a “type” field 404, a “storage LU: LBA” field 405, a “processing upon replication” field 406, and a “replication destination” field 407. Incidentally, the fields of the original content information 145 are not limited to those listed above, and the original content information 145 may also include fields for describing information about other blocks storing the original content. Also, the original content information 145 describes records for each content, but the information collected from another point of view may be represented as one record.

The “frame” field 403 indicates frames belonging to the relevant content. The “type” field 404 indicates the status of the stored content such as the whole content, the first half or second half of the content, images, or sounds. The “storage LU: LBA” field 405 indicates an LU and an LBA (Logical Block Address) where the relevant content is stored. The “processing upon replication” field 406 indicates the details of acknowledged processing for replication. The processing include replications of the first half of the content, the second half of the content, the beginning of the content, the sound portion, the image portion, or the key frames. If the field 406 stores “Any,” it means that any processing may be executed. If the field 406 stores “only partly,” only the processing for replicating part of the content is acknowledged. As other examples, “priority replication of sounds” means that replication of the sound portion should have priority; or “permission of selective extraction” enables selective extraction of differential frames or replication of only the key frames; or if partial replication or selective extraction is not allowed for the relevant content, the field 406 stores “only as a whole.” The “replication destination” field 407 indicates the location of the replicated content if the replication has been performed; or the field 407 stores “No” if the replication has not been performed.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

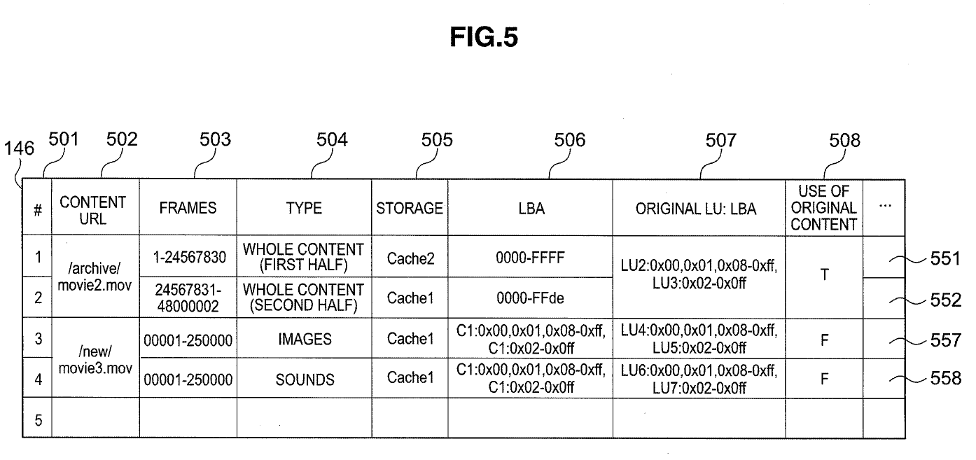

FIG. 5 is the replicated content information 146 showing the status of the content replicated in the pool. The replicated content information 146 includes an “ID” field 501, a “content URL” field 502, a “frame” field 503, a “type” field 504, a “storage LU” field 505, a “storage LBA” field 506, a “replication source LU: LBA” field 507, and a “use of replication source” field 508. Incidentally, the fields of the replicated content information 146 are not limited to those described above, and the replicated content information 146 may include fields describing information about other replicated content. Also, the replicated content information 146 describes records for each fraction of the content, but the information collected from another point of view may be represented as one record.

Since the “content URL” field 502, the “frame” field 503, and the “type” field 504 are similar to those in FIG. 4, description thereof is omitted. The “storage” field 505 indicates the location where the replicated content is stored. The “LBA” field 506 indicates the LBA where the replicated content is stored. The “original LU: LBA” field 507 stores the same information as that in the “storage LU: LBA” field 405. The “use of the original content” field 508 indicates whether or not the original content is to be used when delivering the content. When the original content is to be used, “T” is input to the field 508 and the content is delivered using both the original content and the replicated content. When the original content is not to be used, “F” is input to the field 508. If good delivery performance can be provided with only the replicated content, the original content does not have to be used.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

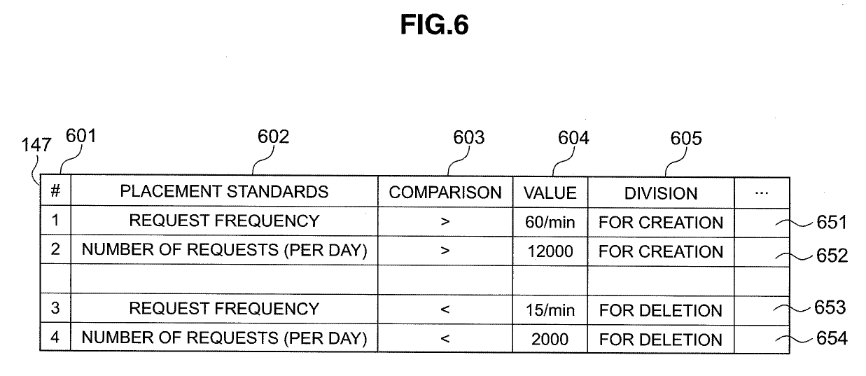

FIG. 6 is the replicated content creation and deletion standards 147 showing the conditions under which whether the content should be replicated and stored in the pool or deleted is determined. The replicated content creation and deletion standards 147 includes an “ID” field 601, a “creation or deletion standards” field 602, a “comparison” field 603, a “value” field 604, and a “division” field 605. The “creation or deletion standards” field 602 stores the condition under which whether the replicated content should be created or deleted is determined. The “comparison” field 603 stores a sign indicating the size of the numerical value of the creation or deletion standards 602 relative to the “value” field 604. The “value” field 604 stores a reference value based on which the replicated content is created or deleted. The “division” field 605 stores “for creation” if the standard is used for replication; or the “division” field 605 stores “for deletion” if the standard is used for deletion of the replicated content. Incidentally, the fields of the replicated content creation and deletion standards 147 are not limited to those listed above, and the replicated content creation and deletion standards 147 may include fields describing information about other replicated content creation and deletion standards. Also, the replicated content creation and deletion standards 147 describe records for each creation or deletion condition, but the information collected from another point of view may be represented as one record.

Records 651-652 are conditions for pool assignment. The content that satisfies any of the conditions is replicated in the pool. The record 651 indicates that the content whose request frequency exceeds 60/min is replicated and stored in the pool. The record 652 indicates that the content whose number of requests per day exceeds 12000 is replicated and stored in the pool. If the content satisfies the condition, the content stored in the pool can be further replicated.

Records 653-654 are conditions for deleting the content that has been replicated and stored in the pool. The content that satisfies any of the conditions is deleted from the pool. The record 653 indicates that the content whose request frequency is lower than 15/min is the target to be deleted from the pool. The record 654 indicates that the content whose number of request per day is less than 2000 is the target to be deleted from the pool. Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

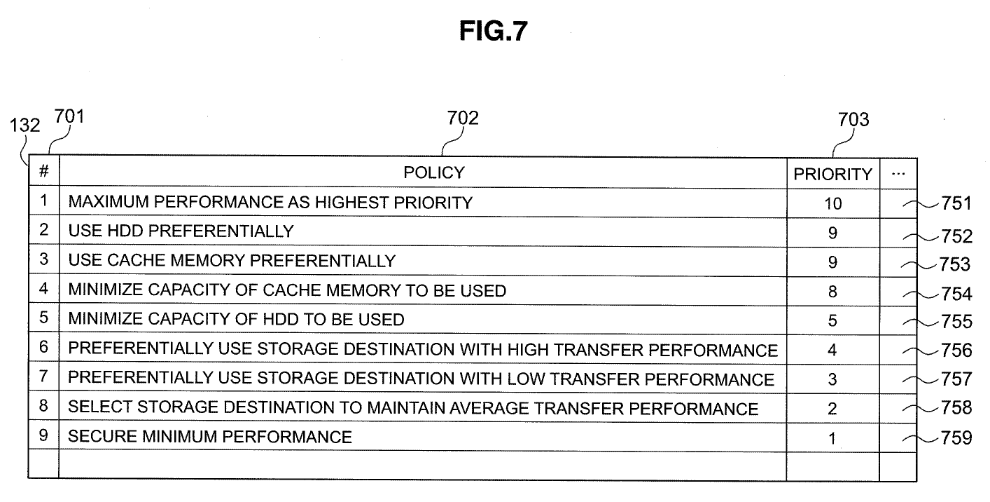

FIG. 7 is the pool selection standards 132 showing priority conditions for pools to store the replicated content. The pool selection standards 132 includes an “ID” field 701, a “policy” field 702, and a “priority” field 703. Incidentally, the fields of the pool selection standards 132 are not limited to those listed above, and the pool selection standards 132 may include fields describing information about other pool selection standards. Also, the pool selection standards 132 describe records for each standard, but the information collected from another point of view may be represented as one record.

A record 751 stores, in the “policy” field 702, “maximum performance as highest priority” indicating as a pool selection standard that a pool of the highest transfer rate should be selected, and the “priority” field 703 stores the numerical value “10” indicating the priority of that standard. The policies of “use HDD preferentially” and “use cache memory preferentially” respectively mean as the pool selection standards that HDD or cache memory should be used preferentially.

### “Efficient and Preferential Use of Cache Memory Resource”

A record 759 stores, in the “policy” field 702, “secure minimum performance” indicating as the pool selection standard that a pool whose transfer rate would at least achieve the target performance should be selected, and the “priority” field 703 stores the numerical value “1” indicating the priority of that standard. Regarding these pool selection standards, the record 751 indicating the condition with a higher priority is given preference over the record 759 and the pool will be selected to secure maximum performance.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

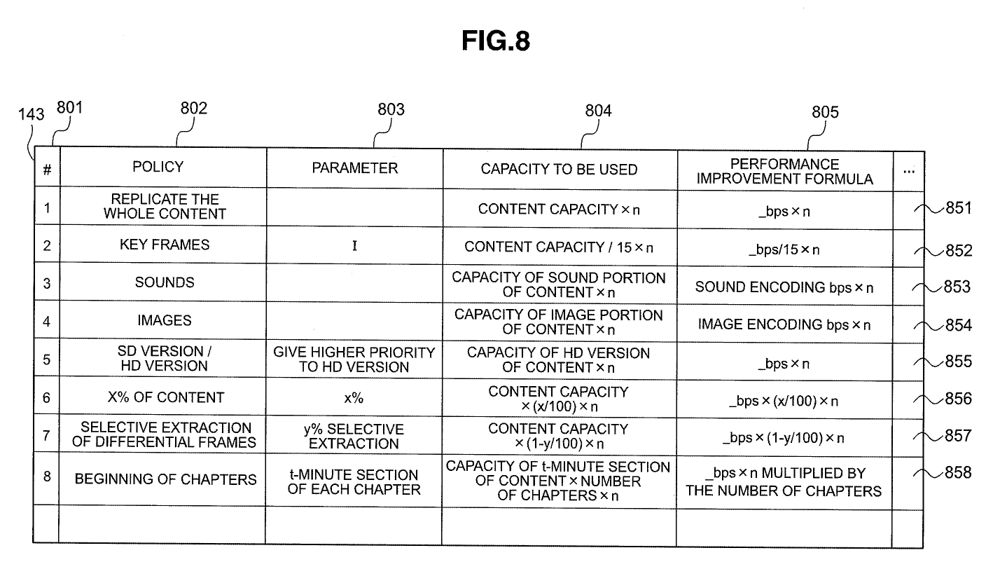

FIG. 8 shows the replication details and performance prediction information 143. The replication details and performance prediction information 143 records parameters for predicting the degree of performance improvement and the capacity of a pool to be used when replicating and storing a certain content in the pool regarding each case, for example, where the whole content is to be replicated or where part of the content is to be replicated after preprocessing. The replication details and performance prediction information 143 includes an “ID” field 801, a “policy” field 802, a “parameter” field 803, a “capacity to be used” field 804, and a “performance improvement formula” field 805. The “policy” field 802 stores the details of processing executed when replicating the content. The “parameter” field 803 stores parameters necessary for calculating, for example, the capacity to be used when creating the replicated content. The “capacity to be used” field 804 indicates the capacity of a pool to be used when executing the preprocessing and then replicating the content and storing it in the pool. The “performance improvement formula” field 805 indicates formulas for calculating improvement of a transfer speed when executing the preprocessing and then replicating the content and storing it in the pool. Incidentally, the fields of the replication details and performance prediction information 143 are not limited to those listed above, and the fields of the replication details and performance prediction information 143 may include fields describing information about other details of replication of the content and the performance prediction. Also, the replication details and performance prediction information 143 describes records for each prediction condition, but the information collected from another point of view may be represented as one record.

The “policy” field 802 will be explained below. A record 851 stores the expression “replicate the whole content” meaning the policy of replicating the whole content. The expression “key frames” means the policy of replicating key frames of the relevant content. The streaming content is composed of key frames and differential frames. If deterioration of the image portion would not be a problem, it is possible to cut down the capacity of the pool to be used by delivering only the key frames. The expression “sounds” means the policy of replicating the sound portion of the relevant portion. Regarding the content whose sounds are valued, it is possible to cut down the capacity to be used and distribute accesses by replicating and delivering the key frames and sounds. The expression “images” means the policy of replicating the image portion of the relevant content. The expression “SD version/HD version” means, if both a SD (standard definition) version and an HD (high definition) version of the relevant content exist, the policy of selecting one of them. It is possible to deal with concentration of accesses or flash crowd by, for example, creating a plurality of SD versions to distribute the accesses. The expression “x % of content” means the policy of replicating the x % range of the content. The replication range may be designated by time. It is possible to distribute accesses efficiently by replicating, for example, the beginning portion of the content on which accesses tends to concentrate. The range of the content to be replicated may be input by, for example, the administrator in advance or be determined adaptively by statistic processing according to the access status. Next, a specific example of a method for determining the replication range by statistic processing will be explained below.

The access pattern information 121 can be used to plot a graph with the period of time spent by the server computer to deliver the content to client computers on the horizontal axis and a ratio of client computers to which the content was delivered until a certain point of time to the total number of client computers on the vertical axis. The ratio of the client computers to which the content was delivered until the certain point of time can be calculated from accesses made in a certain period of time (for example, one hour or one day). Alternatively, the above-described ratio may be calculated from a certain number of accesses, for example, the most recent 1000 accesses. The period of time from the beginning of the content to the point of time when the ratio of the client computers to which the content was delivered to the specified point of time becomes lower than a certain value can be defined as the range of the content to be replicated. Also, the starting point of the replication range is not limited to the beginning of the content, the range of the content where the ratio of the client computers to which the content was delivered exceeds a certain value may be replicated. Moreover, a differential value of the graph may be calculated and the period of time until the differential value becomes maximum or minimum may be used as an indicator of the replication range. Furthermore, relative cumulative frequency distribution of the time when the client computers stopped delivery of the content may be plotted and processing similar to that described above may be executed so that the range of the content until the ratio of the client computers to which the content was delivered to the specified point of time exceeds a certain value is defined as the range of the content to be replicated.

The expression “selective extraction of differential frames” means the policy of selectively extracting and replicating the differential frames of the relevant content. The image quality will deteriorate due to selective extraction, but the capacity to be used will be reduced. The expression “beginning of chapter” means the policy of replicating a t-minute section of the beginning of each chapter. It is possible to distribute accesses efficiently by replicating the beginning of each chapter on which accesses tend to concentrate. The range of the chapters to be replicated may be designated as, for example, “X %.”

In the “parameter” field 803, “I” indicates a ratio of key frames included in the relevant content. For example, one key frame is included in every 15 frames. The expression “give higher priority to HD version” means the policy of giving higher priority to the HD (high definition) version of the same content. The expression “x %” means the policy of replicating the x % range of the relevant content. The expression “y % selective extraction” means the policy of replicating y % of the differential frames. The expression “t minutes” means the policy of replicating each t-minute section from the beginning of the relevant content.

The “capacity to be used” field 804 indicates the capacity to be used for replication. Formulas for calculating the capacity are represented by multiplication of the capacity of the content to be replicated or part of the content to be replicated by the number (n) of the replicated content to be created. The number of the replicated content will be omitted in the following explanation about the capacity calculation. Since one key frame is included in every 15 frames in a record 852, the capacity to be used for replication would be a fifteenth part of the capacity of the relevant content. Since x % of the content is replicated in a record 856, the capacity to be used for replication would be “the content capacity×(x/100).” Since y % of the differential frames is selectively extracted in a record 857, the capacity to be used for replication would be “the content capacity×(1−y/100).” In a record 858, the capacity to be used for replication would be “the capacity of the t-minute section of the content×the number of chapters.” The “performance improvement formula” field 805 stores formulas for calculating improvement of a transfer rate when creating the replicated content. In the “performance improvement formula” field 805, the expression “_bps” means a transfer rate of the original content. This transfer rate is calculated based on a transfer rate of the media (such as HDD or SDD) for storing the replicated content. The transfer rate obtained by the performance improvement formula is different from the transfer rate applied when actually delivering the content from the server; and the transfer rate obtained by the performance improvement formula is used as an indicator of how much improvement will be made to the transfer rate. The larger the value obtained by the improvement formula is, the greater the improvement of delivery performance from the server to the client computers will be.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

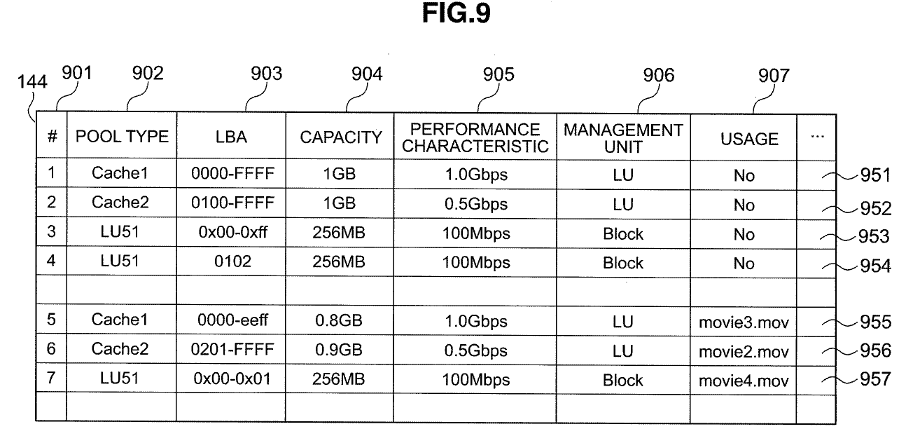

FIG. 9 is the pool management information 144. The pool management information 144 indicates blocks of unused pools or pools in use and the characteristics of these pools. The pool management information 144 includes an “ID” field 901, a “pool type” field 902, an “LBA” field 903, a “capacity” field 904, a “performance characteristic” field 905, a “management unit” field 906, and a “usage” field 907. Incidentally, the fields of the pool management information 144 are not limited to those listed above, and the pool management information 144 may include fields describing information necessary to manage other pools. Also, the pool management information 144 describes records for each block unit (composed of a single block or a plurality of blocks), but the information collected from another point of view may be represented as one record.

The “pool type” field 902 stores the type and number of, for example, the relevant Cache or LU. Also, the type such as NVRAM, SSD, or SATA may be stored. The “LBA” field 903 stores LBAs registered with the relevant pool. The “capacity” field 904 stores the capacity usable as the pool or the capacity used for the pool. The “performance characteristic” field 905 stores a transfer rate of the relevant pool. The “management unit” field 906 stores the unit such as LU or Block for managing the relevant pool. The “usage” field 907 stores the name of the content if the relevant pool is in use; or the “usage” field 907 stores “No” if the relevant pool is not used.

Regarding a record 951, the “pool type” field 902 stores information “Cache1” indicating that the pool type is cache no. 1; the “LBA” field 903 indicates that the LBAs registered with the relevant pool are “0000-ffff”; the “capacity” field 904 indicates that the capacity of the pool is “1 GB”; the “performance characteristic” field 905 indicates that the transfer rate is “1.0 Gbps” as the performance characteristic of the relevant pool; the “management unit” field 906 stores “LU” indicating that the management unit of the relevant pool is the entire logical unit; and the “usage” field 907 stores “No” because the relevant pool is not in use.

Regarding a record 953, the “pool type” field 902 stores information “LU52” indicating that the pool type is HDD no. 51; the “LBA” field 903 indicates that the LBA registered with the relevant pool is “0101”; the “capacity” field 904 indicates that the capacity of the pool is “256 kb”; the “performance characteristic” field 905 indicates that the transfer rate is “100 Mbps” as the performance characteristic of the relevant pool; the “management unit” field 906 stores “Block” indicating that the management unit of the relevant pool is block portions of the LU; and the “usage” field 907 stores “No” because the relevant pool is not in use.

Regarding a record 956, the “pool type” field 902 stores information “Cache2” indicating that the pool type is cache no. 2; the “LBA” field 903 indicates that the LBAs registered with the relevant pool are “0201-FFFF” the “capacity” field 904 indicates that the capacity of the pool is “0.9 GB”; the “performance characteristic” field 905 indicates that the transfer rate is “0.5 Gbps” as the performance characteristic of the relevant pool; the “management unit” field 906 stores “LU” indicating that the management unit of the relevant pool is the entire logical unit; and the “usage” field 907 indicates that the relevant pool is in use.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

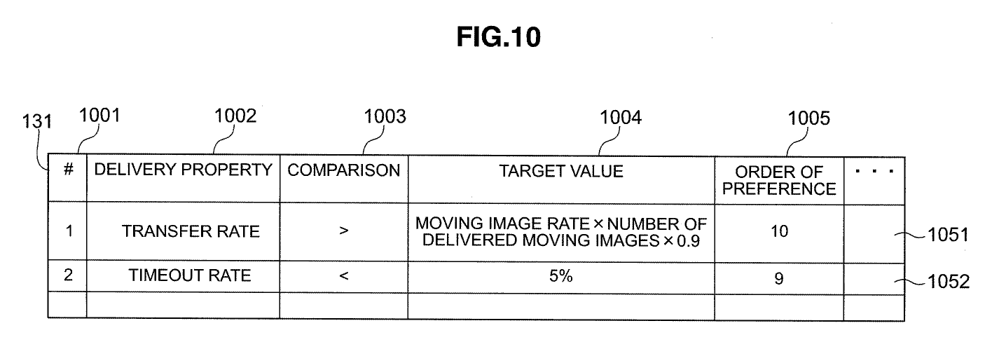

FIG. 10 is the delivery target information 131 for managing numerical values of delivery targets for the streaming system. The delivery target information 131 includes an “ID” field 1001, a “delivery property” field 1002, a “comparison” field 1003, a “target value” field 1004, and a “order of preference” field 1005. Incidentally, the fields of the delivery target information 131 are not limited to those listed above, and the delivery target information 131 may include fields describing information necessary to mange other delivery targets. Also, the delivery target information 131 describes records for each block unit (composed of a single block or a plurality of blocks) of the relevant pool, but the information collected from another point of view may be represented as one record.

The “delivery property” field 1002 stores a delivery target item. The “target value” field 1004 stores a numerical value of the delivery target. The “order of preference” field 1005 stores the priority in application of the delivery target.

A record 1051 indicates that the goal of making the transfer rate faster than “the moving image rate×the number of delivered moving images×0.9” is set. This means that since the ideal transfer rate is “the moving image rate×the number of delivered moving images,” realizing the transfer rate exceeding 90% of the ideal transfer rate is set as the goal.

The record 1052 indicates that the timeout rate is set as a reference for the goal. The timeout rate is a ratio of the number of pieces of the content that failed to be delivered to the number of requests from clients. If the timeout rate is high, this means that the sufficient amount of the content failed to be delivered to satisfy the amount of requests. Therefore, making the timeout rate smaller is set as the goal.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

FIG. 15 is the original-to-replicated blocks correspondence information 115. The original-to-replicated blocks correspondence information 115 manages a correspondence relationship between the original content and the replicated content in the pool. The original-to-replicated blocks correspondence information 115 includes an “original block” field 1501 and a “replicated block” field 1502. Incidentally, the fields of the original-to-replicated blocks correspondence information 115 are not limited to those listed above, and the original-to-replicated blocks correspondence information 115 may include fields describing information necessary to manage other blocks. Also, the original-to-replicated blocks correspondence information 115 describes records for each block, but the information collected from another point of view may be represented as one record.

A record 1551 indicates that the block address of the original content is “LU1” and the block of the original content is “0x00,” while the block address of the replicated content is “LU51” and the block of the replicated content is “0x00.” A record 1552 stores similar information.

Incidentally, record expressions are not limited to those described above, and other descriptions or expressions may be used, and the records may be expressed by a combination of tables, not by a single table. Incidentally, the number of records is not limited to those described above, and any number equal to or more than zero may be used.

A processing sequence executed by the pool management unit 141 according to this embodiment will be explained below.

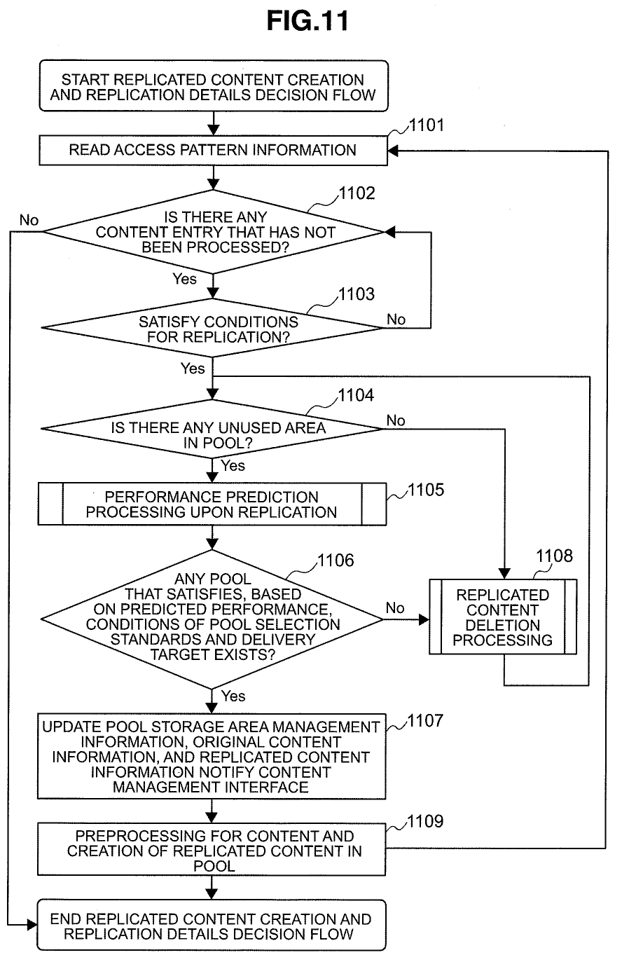

FIG. 11 is a flow of content replication processing. Once the pool management unit 141 starts the content replication processing flow, the pool management unit 141 reads the access pattern information 121 (step 1101).

Next, the pool management unit 141 checks if there is any content entry that has not been processed (step 1102). If there is any unprocessed content, the processing proceeds to step 1103.

Subsequently, the pool management unit 141 compares the access pattern information 121 with the replicated content creation and deletion standards 147. Then, the pool management unit 141 determines that the content that satisfies the conditions “for creation” in the “division” field 605 should be replicated (step 1103). Specifically speaking, the pool management unit 141 reads the record 351 and finds the request frequency “70/min” in the “request frequency” 311 exceeds the request frequency “60/min” in the “request frequency” field 604. As a result, the pool management unit 141 determines to replicate “movie1.mov.”

If there is no entry that satisfies the conditions, the processing returns to step 1102 and then proceeds to process the next content entry.

If there is any content entry that satisfies the conditions, the pool management unit 141 checks by referring to the pool management information 144 if there is any unused area in a pool(s) (step 1104).

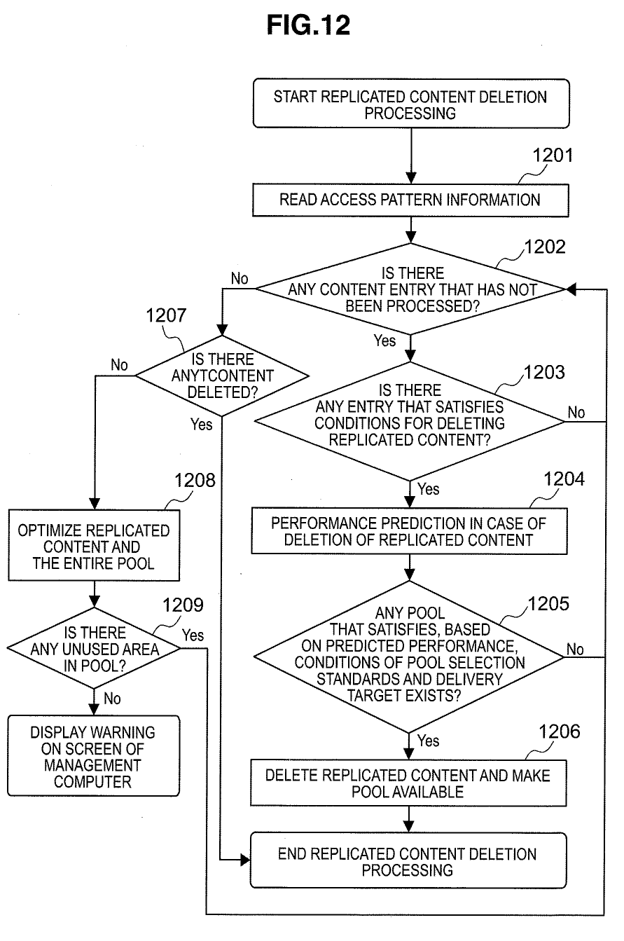

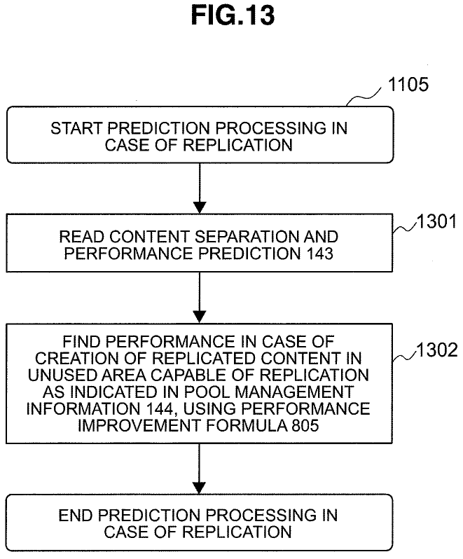

If there is any unused area in a pool(s), the processing proceeds to step 1105 and the pool management unit 141 performs performance prediction in the case where the whole content is replicated and stored in the relevant pool and in the case where part of the content is replicated and stored in the pool. The partial replication means, for example, replications of the key frames, the sound portion, or the image portion, or replications by designating the range of the content as explained with reference to the replication details and performance prediction information 143. If there is no unused area in a pool(s), the pool management unit 141 executes replicated content deletion processing in step 1108. The replicated content deletion processing is the processing for deleting the replicated content in the pool, to which a small number of accesses is made, and which is not being used. Specifically speaking, the pool management unit 141 checks the “usage” field 907 and the “capacity” field 904 for the records 951-954; and since there are unused pools, the pool management unit 141 executes step 1105. The details of step 1108 will be explained with reference to FIG. 12. Also, the details of step 1105 will be explained with reference to FIG. 13.

Next, the pool management unit 141 judges, based on the performance predicted in step 1105, whether any pool that satisfies the policy described in the pool selection standards 132 as well as the delivery target 131 exists or not (step 1106). The pool management unit 141 checks the pools by gradually lowering the priorities of the pool selection standards 132 and the delivery target 131 respectively until it finds any pool that satisfies the pool selection standards 132 and the delivery target 131. If there is no pool that satisfies the pool selection standards 132 and the delivery target 131, the pool management unit 141 executes the replicated content deletion processing (step 1108).

Specifically speaking, since the record 751 has the highest priority, the pool and the details of replication that would improve the delivery performance to the maximum when replicating the content is selected. The details of replication that match the “processing upon replication” field 406 are selected, and, for example, the key frames, the sound portion, or the designated range is determined. At this point in time, the pool management unit 141 determines that the whole content should be stored in Cache1 according to the record 851 in the replication details and performance prediction information 143 and the record 951 in the pool management information 144.

After determining the details of replication and the pool, the pool management unit 141 updates the pool management information 144, the original content information 145, and the replicated content information 146, and sends an instruction for replication to the content management unit 102 (step 1107). Specifically speaking, the pool management unit 141 inputs the LBA(s) to be used to the “LBA” field 903 in the pool management information 144, inputs the capacity to be used to the “capacity” field 904, and inputs the content name to the “usage” field 907. Also, the pool management unit 141 inputs the pool name of the replication destination to the original content information 145. Furthermore, the pool management unit 141 inputs each piece of detailed information to the replicated content information 146.

Next, if part of the content is to be replicated, the content analyzing unit 142 executes the processing for replicating part of the content. The storage apparatus stores the replicated content in the pool in accordance with the instruction (step 1109).

After the termination of the replication processing, the processing returns to step 1102 and proceeds to the following steps. After processing all the pieces of the content, the replicated content creation processing flow is terminated.

FIG. 12 is a flow of the replicated content deletion processing executed in step 1108 in FIG. 11. This is the processing for deleting the content that was replicated in the pool, and to which only a small amount of accesses has been made.

Once starting the replicated content deletion processing in step 1108, the pool management unit 141 reads the access pattern information 121 (step 1201).

Next, the pool management unit 141 checks if there is any content entry that has not been processed (step 1202). If there is any unprocessed content, the processing proceeds to step 1203.

The pool management unit 141 then compares the access pattern information 121 with the replicated content creation and deletion standards 147. The pool management unit 141 determines to delete the content that satisfies the conditions “for deletion” in the “division” field 605, from the relevant pool (step 1203). Specifically speaking, if the request frequency of the content is less than “15/min” or the number of requests for the content per day is less than 2000, that content should be deleted from the pool.

If there is no entry that satisfies the conditions, the processing returns to step 1202 and proceeds to the next content entry.

Next, performance prediction is carried out in the case of deletion of the content that satisfies the conditions (step 1204).

The pool management unit 141 compares the performance predicted in step 1204 with the delivery target information 131 (step 1205). If deletion of the replicated content would not achieve the delivery target, the processing returns to step 1202. If deletion of the replicated content would achieve the delivery target, the replicated content in the pool is deleted. The pool management unit 141 updates the original content information 145, the replicated content information 146, and the access pattern information 121, and then notifies the content management unit 102 to that effect.

Specifically speaking, the record 352 stores the performance value of the original content and the records 353, 354 respectively store the performance values of the replicated content. If the records 353, 354 are deleted, what is predicted is adoption of the performance value in only the record 352. Since the transfer rate “235 Mbps” in the record 352 meets the delivery target 1051, the pool management unit 141 determines that the content satisfies the performance. The pool management unit 141 updates the “replication destination” field 407 for the record 453 to “No,” deletes the records 557, 558 in the replicated content information, and makes the “usage” field 907 for a record 958 in the pool management information 144 indicate that the relevant pool is unused.

When all the content entries have been processed, the processing proceeds to step 1207. If there is no deleted content, the pool management unit 141 optimizes the replicated content and the entire pool (step 1208).

Next, the processing proceeds to step 1209; and if any unused pool is obtained as a result of the optimization, the processing returns to step 1202 and proceeds to the following steps. If no unused pool is obtained as a result of the optimization, the pool management unit 141 displays a warning on the screen of the management computer.

FIG. 13 is a flow of the performance prediction processing executed in step 1105 in FIG. 11 when creating the replicated content in the pool. Once starting the performance prediction processing, the pool management unit 141 reads the replication details and performance prediction information 143 (step 1301).

The pool management unit 141 finds the performance that will be improved if the content is replicated and stored in an unused area capable of replication as indicated in the pool management information 144 in accordance with the information stored in the “processing upon replication” field 406 for each entry and using the “performance improvement formula” field 805 (step 1302).

Specifically speaking, as a result of evaluating the record 851 with regard to “movie1.mov” indicated in the record 351, it is found based on the “capacity to be used” field 804 that the records 951-952 can store the content of the file size “0.75 GB” (indicated in the “file size” field 304) multiplied by the number “n” of the pieces of the replicated content. The performance of the records 951 and 952 is calculated as “1.0 Gbps×n” and “0.5 Gbps×n” respectively in accordance with the performance improvement formulas. Next, the record 852 is evaluated and the performance to be improved is calculated for the records 951-954 that can store, based on the “capacity to be used” field 804, the file size “0.75 GB” (indicated in the “file size” field 304) multiplied by the number “n” of the pieces of the replicated content and divided by 15. Since the “processing upon replication” field 406 stores “Any,” all the entries in the replication details and performance prediction information 143 are processed. If the “processing upon replication” field 406 stores “only partly,” calculation is performed for only the entries relating to the partial replication.

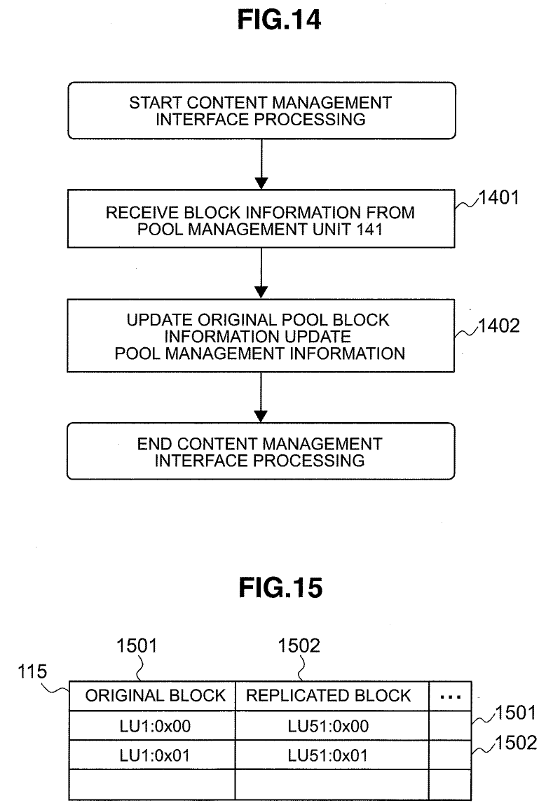

FIG. 14 is a flow of processing executed by the content management unit 102 for managing block information about the original content and the replicated content.

The content management unit 102 receives block information from the pool management unit 141 (step 1401).

If the received information is block information about pool replication, the content management unit 102 replicates blocks of the relevant content stored in the original content storage area and store them in blocks of the designated pool storage area 104; and the content management unit 102 updates the original-to-replicated blocks correspondence information 115 and the pool management information 144 (step 1402).

Specifically speaking, if an instruction is given to create the replicated content of the record 451 in the pool 953, since regarding the block “0x00” constituting the relevant content, the original block 1501 is “LU1: 0x00” and the replication destination 953 is “LU51,” the record 1501 is added so that the record 1502 will become “LU51: 0x00.” Also regarding the next block “0x01,” the record is added as 1552 in the same manner; and record entries are added to the respective blocks configured thereafter. Subsequently, the entry for the record 953 in the pool management information 144 is modified so that the field 907 indicates the relevant pool is being used by movie1.mov, and a new record is added for the area being used as, for example, a record 959 (in this example, only “0x00” and “0x01” are described).

If the information received in step 1401 is information about deletion of block(s), the content management unit 102 deletes the relevant entry (or entries) and updates the pool management information. In the above-described example, the content management unit 102 deletes the records 1501-1502, modifies the relevant entry to make the field 907 for the record 953 indicate the relevant pool is not being used, and then deletes the record 959 which is the area in use.

Incidentally, updates of the pool management information 144 in the above-described processing flow may be performed either by the content management unit, as described in this example, or the management server.

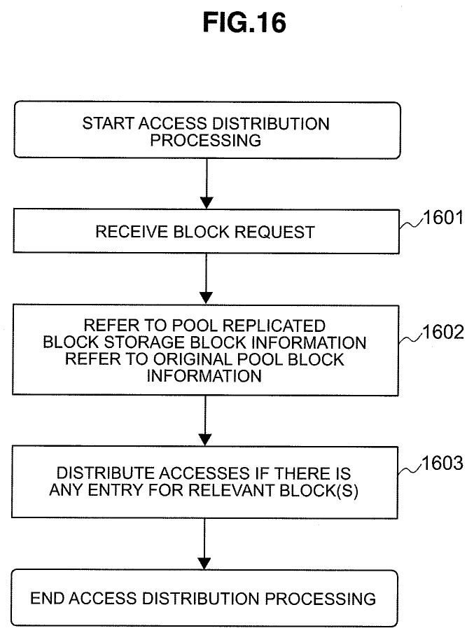

FIG. 16 illustrates a flow of processing for distributing access to the original content storage area 106 and the pool storage area 104 when a request for access to the content is made. When a request for access to the content is made, the delivery unit 123 transmits a block request to the driver 124 or the storage apparatus 220.

After the driver 124 or the storage apparatus receives the block request (step 1601), it refers to the replicated content information 146 or the original-to-replicated blocks correspondence information 115 and checks if the block of the relevant content is included in that information (step 1602). If access is made to a block “0x00 of LU1” of movie1.mov in the record example mentioned above, since it is apparent that the block is included in the field 507 for the record 551 in the replicated content information 146, reference is made to the relevant pool LBA in 505, 506, and it is then found that the relevant block is stored in “0x00 of Cache2.” Alternatively, reference is made to the original-to-replicated blocks correspondence information and the relevant entry is found in the field 1501 for a record 1551 and, therefore, it is found that the relevant block is stored in “0x00 of LU51” based on 1502. Local accesses can be reduced by appropriately assigning the accesses to the pool blocks found in step 1602. Regarding the blocks to be delivered, original blocks and replicated blocks may be assigned alternately or according to a transfer performance rate. If the ratio of the transfer rate for the original content storage area to the transfer rate for the pool storage area is 1:3, the original blocks and the replicated blocks may be assigned at the ratio of 1:3.

If only part of the content (for example, only the beginning of the content) is replicated, access to the portion of the content whose replicated data exists may be assigned to both the original content and the replicated content as described above, and the content whose replicated data does not exist is delivered from the original content storage area.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. A computer system comprising a server computer and a storage apparatus connected to the server computer,
wherein the storage apparatus has a first storage unit and a second storage unit;
if access is made to streaming data stored in the first storage unit, the server computer delivers the data from the first storage unit;
if the access to the data satisfies specified conditions, the server computer notifies the storage apparatus of the range of the data to be replicated; and
the storage apparatus replicates the notified range of the data from the first storage unit to the second storage unit.

2. The computer system according to claim 1, wherein the server computer measures delivery time from the start of delivery to the end of delivery; and based on the delivery time and the number of client computers to which the data was delivered until the end of the delivery time, the server computer finds a point of time when the number of client computers to which the data was delivered becomes equal to or less than a certain ratio; and the server computer determines that the range of the data delivered until the number of client computers becomes equal to or less than the certain ratio should be replicated.

3. The computer system according to claim 1, wherein the server computer measures the frequency of access to the data; and if the frequency of access to the data is equal to or more than a certain value, the server computer notifies the storage apparatus of replication of the data.

4. The computer system according to claim 3, wherein the server computer measures the frequency of access to the replicated data; and if the frequency of access to the replicated data is equal to or more than a certain value, the server computer notifies the storage apparatus of replication of the replicated data.

5. The computer system according to claim 1, wherein if access is made to the data, the server computer delivers either the data stored in the first storage unit or the replicated stored in the second storage unit.

6. The computer system according to claim 5, wherein the server computer stores a correspondence relationship between logical block addresses of the data and logical block addresses of the replicated data; and if access is made to a block constituting the data and if there is a block constituting the replicated data corresponding to the block constituting the data, the server computer delivers the block constituting the data or the block constituting the replicated data.

7. The computer system according to claim 1, wherein when replicating the data, the server computer checks if the second storage unit has any area for storing the data; and if the second storage unit has no area for storing the data, and if access to data stored in the second storage unit satisfies specified conditions, the server computer notifies the storage apparatus of an instruction to delete the data in the second storage unit, and the storage apparatus deletes the data concerning which it has received the instruction.

8. The computer system according to claim 7, wherein the server computer measures the frequency of access to the data in the second storage unit; and if the access frequency is lower than a certain value, the server computer determines to delete the data in the second storage unit.

9. A data replication method for a computer system comprising a server computer and a storage apparatus connected to the server computer, the storage apparatus having a first storage unit and a second storage unit,
wherein if access is made to streaming data stored in the first storage unit, the server computer delivers the data from the first storage unit;
if the access to the data satisfies specified conditions, the server computer notifies the storage apparatus of the range of the data to be replicated; and
the storage apparatus replicates the notified range of the data from the first storage unit to the second storage unit.

10. The data replication method for the computer system according to claim 9, wherein the server computer measures delivery time from the start of delivery to the end of delivery; and based on the delivery time and the number of client computers to which the data was delivered until the end of the delivery time, the server computer finds a point of time when the number of client computers to which the data was delivered until the end of the delivery time becomes equal to or less than a certain ratio; and the server computer determines that the range of the data delivered until the number of client computers becomes equal to or less than the certain ratio should be replicated.

11. The data replication method for the computer system according to claim 9, wherein the server computer measures the frequency of access to the data; and if the frequency of access to the data is equal to or more than a certain value, the server computer notifies the storage apparatus of replication of the data.

12. The data replication method for the computer system according to claim 11, wherein the server computer measures the frequency of access to the replicated data; and if the frequency of access to the replicated data is equal to or more than a certain value, the server computer notifies the storage apparatus of replication of the replicated data.

13. The data replication method for the computer system according to claim 9, wherein if access is made to the data, the server computer delivers either the data stored in the first storage unit or the replicated stored in the second storage unit.

14. The data replication method for the computer system according to claim 13, wherein the server computer stores a correspondence relationship between logical block addresses of the data and logical block addresses of the replicated data; and if access is made to a block constituting the data and if there is a block constituting the replicated data corresponding to the block constituting the data, the server computer delivers the block constituting the data or the block constituting the replicated data.

15. The data replication method for the computer system according to claim 9, wherein when replicating the data, the server computer checks if the second storage unit has any area for storing the data; and if the second storage unit has no area for storing the data, and if access to data stored in the second storage unit satisfies specified conditions, the server computer notifies the storage apparatus of an instruction to delete the data in the second storage unit, and the storage apparatus deletes the data concerning which it has received the instruction.

16. The data replication method for the computer system according to claim 15, wherein the server computer measures the frequency of access to the data in the second storage unit; and if the access frequency is lower than a certain value, the server computer determines to delete the data in the second storage unit.
